(19) United States
(12) Patent Application Publication
(10) Pub. No.: US 2007/0050233 A1
(43) Pub. Date: Mar. 1, 2007

(54) System and method for synchronizing sales order confirmations with material flow determinations

(76) Inventors: Andre Doerfler, Mannheim (DE); Thomas Gross-Boelting, Walldorf (DE); Bernhard Lokowandt, Heidelberg (DE); Dirk Meier-Barthold, Forst (DE); Stefan Siebert, Hockenheim (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/213,168

(22) Filed: Aug. 25, 2005

(51) Int. Cl. G06F 17/30

(52) U.S. Cl. 705/10

(57) ABSTRACT

A computer system and method for synchronizing sales order confirmations and material flow determinations in a supply chain management (SCM) environment. For example, a method according to one embodiment of the invention comprises: receiving an indication of a new sales order having associated therewith a desired quantity and a desired delivery date; determining whether the desired quantity can be promised by the desired delivery date based on current receipts; and generating a fixed pegging relationship between the new sales order and receipts identified to satisfy the sales order if the desired quantity can be promised by the desired date.

### BACKGROUND

1. Field of the Invention

This invention relates generally to the field of data processing systems. More particularly, the invention relates to a system and method for synchronizing sales order confirmations with material flow determinations within a supply chain management (“SCM”) system.

2. Description of the Related Art

Certain software applications are designed to comprehend complicated scheduling tasks. For example, as illustrated in FIG. 1, a supply-chain-management (“SCM”) software application 110 is typically designed to comprehend the resources in a supply chain (e.g., raw materials, manufacturing equipment, distribution, warehousing, etc) and schedule their usages (also referred to as “activities”) so that a specific “supply” of product can be provided at one or more places at specific times to meet the anticipated “demand” for the product.

More advanced SCM applications provide functions for intra- and inter-company supply chain planning and for scheduling and monitoring of associated supply chain processes. For example, the assignee of the present application has developed an advanced supply chain management platform known as the Advanced Planner & Optimizer (“APO”) which, as described in Gerhard Knolmayer, et al., SUPPLY CHAIN MANAGEMENT BASED ON SAP SYSTEMS (hereinafter “Knolmayer”), includes different modules for implementing various interrelated SCM functions. As illustrated in FIG. 1, these modules include (but are not limited to) a production planning and detailed scheduling (“PP/DS”) module 101, an available to promise (“ATP”) module 102, a supply network planning (“SNP”) module 103, a transportation planning/vehicle scheduling (“TPNS”) module 104, and a demand planning (“DP”) module 105. The SCM architecture shown in FIG. 1 also includes one or more SAP R/3 systems for processing incoming sales orders from customers.

The ability to accurately forecast demand is an important precondition to any production planning schedule. With this goal in mind, the DP module 105 attempts to determine the demand for a product over a specified time period. Current demand planning techniques are largely based on empirical data 100 for a given product such as, e.g., historical demand data stored within an archiving system, data warehouse or other database 120.

SNP and PP/DS both fall into the general category of “advanced planning and scheduling” or “APS” which involves the planning and scheduling of materials and resources within the supply chain. SNP differs from PP/DS in terms of the time horizon used for planning and scheduling. The SNP module 103 is used for tactical (i.e., midterm) planning calculations, whereas the PP/DS module 101 is used for operational (i.e., short-term) planning calculations. For example, a typical planning horizon for SNP may be in the range of 3-6 months whereas a typical planning horizon for PP/DS may be in the range of 1-7 days.

The TP/VS module 104 employs techniques to optimize the delivery of products using different transportation routes and vehicles. It enables manufacturers, retailers, and logistics providers to coordinate transportation resources via the Internet and to synchronize transportation decisions and activities. The transportation planning component of TPNS focuses on medium- to long-term planning whereas the vehicle scheduling component focuses on short-term planning and routing.

The ATP module 102 is responsible for determining whether a product can be promised by a specified delivery date in response to a customer request. If a given product is not in stock, ATP coordinates with other modules such as PP/DS to determine whether the product can be procured from alternate sources and/or manufactured in time to fulfil the customer request.

One problem which exists with current SCM systems is the lack of synchronization between the material resource planning of the PP/DS module 101 and the order confirmations generated by the ATP module 102. Specifically, the confirmation decision provided by the ATP module 102 is based on the current state of production and supply chain planning but the confirmation does not force a corresponding material flow determination in the multi-stage PP/DS production and supply chain planning. Thus, the sales order confirmation and the material flow determination may ultimately differ. Consequently, problems to deliver the sales orders as confirmed can occur.

Accordingly, what is needed is an SCM system which provides for improved synchronization between the ATP confirmation decision and the corresponding material flow determination.

### SUMMARY

A computer system and method are described for synchronizing sales order confirmations with material flow determinations in a supply chain management (SCM) environment. For example, a method according to one embodiment of the invention comprises: receiving an indication of a new sales order having associated therewith a desired quantity and a desired delivery date; determining whether the desired quantity can be promised by the desired delivery date based on current receipts; and generating a fixed pegging relationship between the new sales order and receipts identified to satisfy the sales order if the desired quantity can be promised by the desired date.

### BRIEF DESCRIPTION OF THE DRAWINGS

A better understanding of the present invention can be obtained from the following detailed description in conjunction with the following drawings, in which:

FIG. 1 illustrates an exemplary prior art supply chain management system designed by the assignee of the present application.

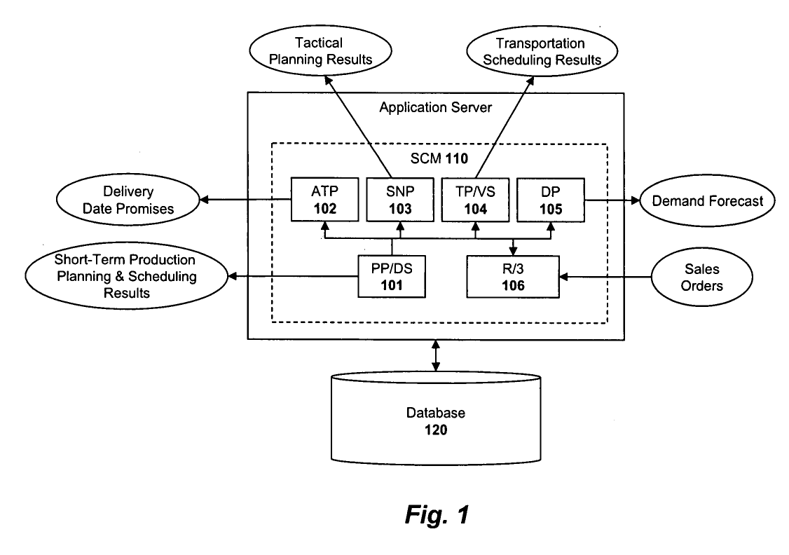

FIG. 2 illustrates a system architecture including a material flow/sales order synchronization module according to one embodiment of the invention.

FIG. 3 illustrates fixed pegging operations associated with a sales order according to one embodiment of the invention.

FIG. 4 illustrates fixed pegging operations associated with a sales order quantity increase according to one embodiment of the invention.

FIG. 5 illustrates fixed pegging operations associated with a sales order quantity decrease according to one embodiment of the invention.

FIG. 6 illustrates fixed pegging operations associated with a sales order date shift forward according to one embodiment of the invention.

FIG. 7 illustrates fixed pegging operations associated with a sales order date shift backward according to one embodiment of the invention.

FIG. 8 illustrates fixed pegging operations associated with a sales order with additional scheduling line according to one embodiment of the invention.

FIG. 9 illustrates fixed pegging operations associated with a sales order quantity increase according to one embodiment of the invention.

FIG. 10 illustrates fixed pegging operations associated with a sales order quantity decrease according to one embodiment of the invention.

FIG. 11 illustrates fixed pegging operations associated with a sales order date shift forward according to one embodiment of the invention.

FIG. 12 illustrates fixed pegging operations associated with a sales order date shift backward according to one embodiment of the invention.

FIG. 13 illustrates fixed pegging operations associated with a sales order with additional scheduling line according to one embodiment of the invention.

FIG. 14 illustrates fixed pegging operations associated with the creation of dependent requirement according to one embodiment of the invention.

FIG. 15 illustrates fixed pegging operations associated with an increase of the dependent requirement according to one embodiment of the invention.

FIG. 16 illustrates fixed pegging operations associated with a decrease of a requirement quantity according to one embodiment of the invention.

FIG. 17 illustrates fixed pegging operations associated with a dependent requirement forward shift according to one embodiment of the invention.

FIG. 18 illustrates fixed pegging operations associated with a dependent requirement backward shift according to one embodiment of the invention.

FIG. 19 illustrates a computer system architecture according to one embodiment of the invention.

### DETAILED DESCRIPTION OF PREFERRED EMBODIMENTS

Described below is a system and method for synchronizing sales order confirmations with material flow determinations within a supply chain management (“SCM”) system. Throughout the description, for the purposes of explanation, numerous specific details are set forth in order to provide a thorough understanding of the present invention. It will be apparent, however, to one skilled in the art that the present invention may be practiced without some of these specific details. For example, although many of the embodiments described herein are based on the APO and/or R/3 architectures developed by the assignee of the present application, the underlying principles of the invention are not limited to any specific SCM architecture. In other instances, well-known structures and devices are shown in block diagram form to avoid obscuring the underlying principles of the present invention.

In one embodiment of the invention, in order to synchronize sales order confirmations and material flow determinations within a multi-sage production and supply chain environment, the material flow determinations are linked directly (e.g., coupled to or integrated into) the sales order confirmations. Before a sales order is created it obviously cannot be considered in planning. At this stage, production is often planned against the demand forecast. At a later point in time, a sales order is entered. During sales order entry, the demand forecast is consumed, an ATP check is performed to determine availability, and the sales order is created. ATP is checked either against receipts (also known as “production orders” or POs) created earlier to cover the forecast or a “capable to promise” (CTP) check is performed. A CTP check is a relatively more advanced check in which the necessary receipts are created dynamically. For example, under a CTP check, it is often not the availability of the sellable product which is checked but rather the availability of the components which comprise the sellable product. Production of the sellable product is subsequently triggered using the components.

In one embodiment of the invention, in response to new sales orders “fixed pegging” relationships are established between the sales orders and allocated receipts. As used herein, “fixed pegging” refers to the matching of specific sales order confirmations with specific receipts. Using the fixed pegging techniques described herein, sales order confirmations and material flow determinations are ensured to be based on the same relationships, thereby improving synchronization between production planning and sales order confirmations. For example, improved visibility of ATP results in production planning allows planners to consider due date constraints set by confirmed sales orders in the multi-stage production and supply chain environment.

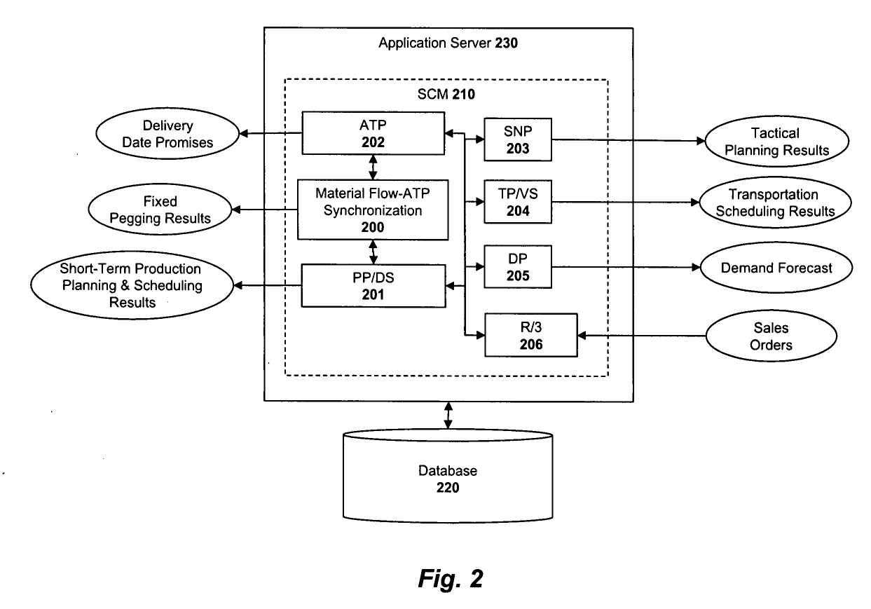

FIG. 2 illustrates an architecture according to one embodiment of the invention which includes material flow-sales order synchronization logic 200 (hereinafter “synchronization module”) for executing the PPDS/ATP synchronization techniques described herein. As illustrated, the synchronization module 200 is part of a larger SCM application 210 executed on an application server 230 which includes a production planning/detailed scheduling (“PP/DS”) module 201, an available to promise (“ATP”) module 202, a supply network planning (“SNP”) module 203, a transportation planning/vehicle scheduling (“TPNS”) module 204, a demand planning (“DP”) module 205 and R/3 systems 206 (e.g., to receive data related to new sales orders). The SCM system also includes an SCM database 220 for storing persistent data related to the various SCM processes.

In one embodiment, each of the modules illustrated in FIG. 2 are implemented as program code stored in memory and executed by a central processing unit on an application server 230 (or spread across multiple application servers). Once again, however, the underlying principles of the invention are not limited to any specific hardware/software or SCM application architecture.

In one embodiment of the invention, two PPDS/ATP confirmation types are processed by the synchronization module 200: 1) PPDS/ATP confirmations against available receipts; and 2) PPDS/ATP confirmations against fixed-pegged receipts. Following the description of these embodiments is a description of 3) the creation of fixed pegging relationships during multi-level planning actions.

### 1. PPDS/ATP Confirmations Against Available Receipts

In the case of PPDS/ATP confirmations against available receipts, existing fixed pegging relationships to the processed sales order are deleted before new fix pegging relationships according to the ATP confirmation are created. System behavior for the creation of fixed pegging relationships within the PPDS/ATP confirmation process will be described using the following examples:
a) Sales order creation
b) Sales order quantity increase
c) Sales order quantity decrease
d) Sales order date is shifted foreword
e) Sales order date is shifted backward
f) Sales order with several scheduling lines

(a) Sales Order Creation

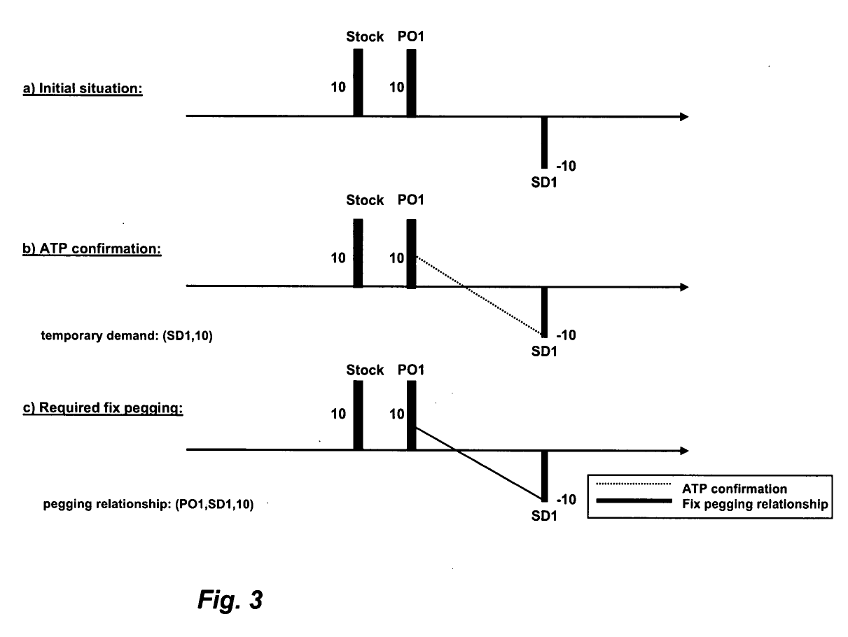

Referring to FIG. 3, a new sales order SD1 having a quantity of 10 is created in R/3 via a customer transaction. As a result, a temporary sales order is created with the quantity of 10, which is fix-pegged to the receipt PO1. In this example, after saving the PPDS/ATP confirmation result, the synchronization module 200 creates a single fixed-pegging relationship between the sales order SD1 and the receipt PO1 with a flow quantity of 10.

(b) Sales Order Quantity Increase

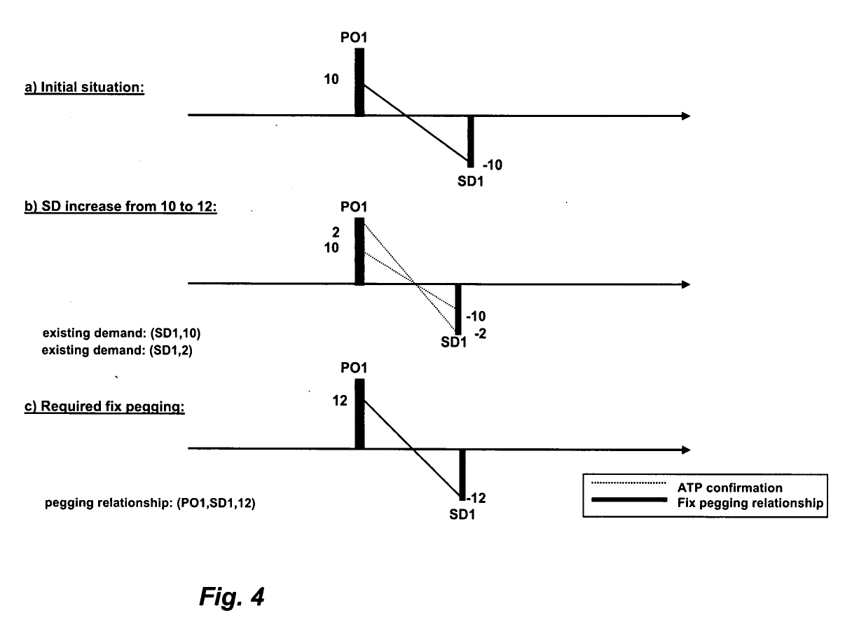

In the example shown in FIG. 4, an existing sales order SD1 is increased in R/3 via a transaction from 10 up to 12. As a result, the a temporary sales order is created with the quantity of the increase (i.e., 2) which is then fix-pegged to the receipt PO1. In this example, after saving the PPDS ATP confirmation result, the synchronization module 200 deletes the existing fixed pegging relationship and creates a single fixed-pegging relationship between the increased sales order SD1 and the receipt PO1 (i.e., with a total flow quantity of 12 in the illustrated example).

(c) Sales Order Quantity Decrease

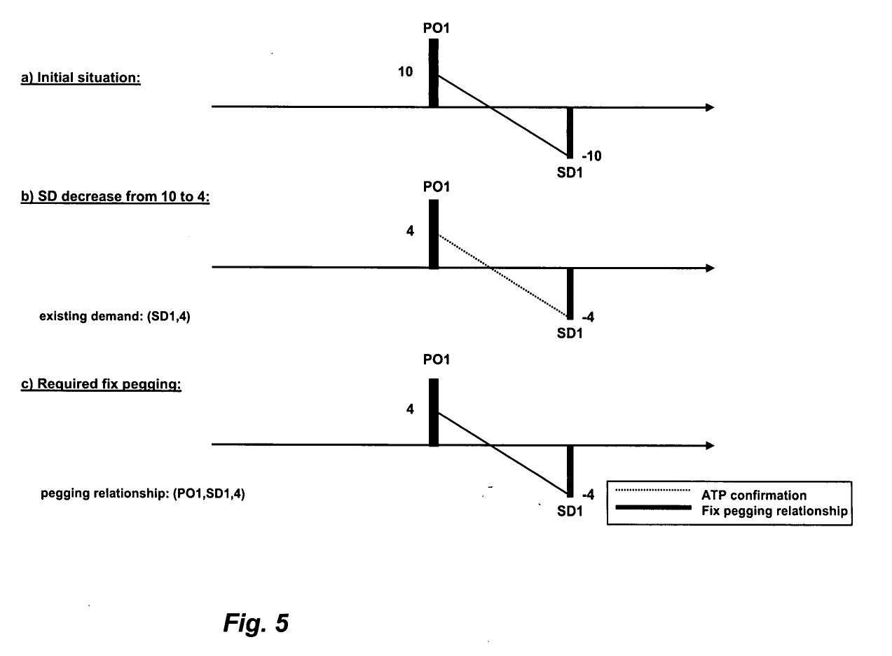

In the example shown in FIG. 5, an existing sales order SD1 is decreased in R/3 from 10 down to 4. As a result, the ATP confirmation amount is decreased. After saving the ATP confirmation result, the synchronization module 200 deletes the exiting fixed-pegging relationship and establishes a single fixed-pegging relationship between the decreased sales order SD1 and the receipt PO1 (i.e., with a flow quantity of 4).

(d) Sales Order Date Shift Forward

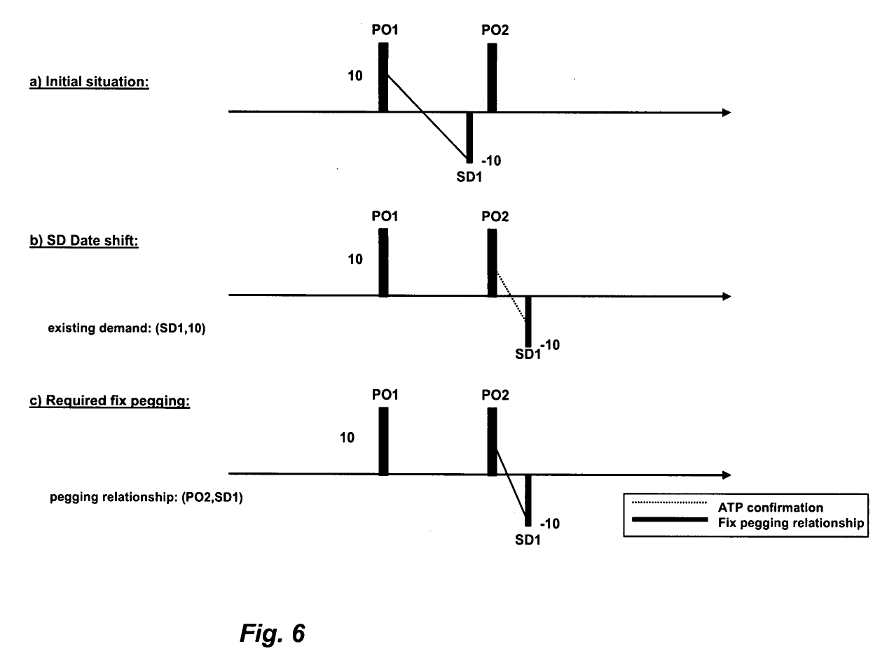

In the example shown in FIG. 6, an existing sales order SD1 is modified in R/3 by shifting the requested date forward. An ATP confirmation is then executed using the new date. In this example, the synchronization module 200 deletes the initial fixed pegging relationship between SD1 and PO1 and creates a new fixed pegging relationship between the shifted sales order SD1 and a new receipt PO2 positioned closer in time to the shifted sales order SD1 (using a flow quantity of 10 in the example).

(e) Sales Order Date Shift Backward

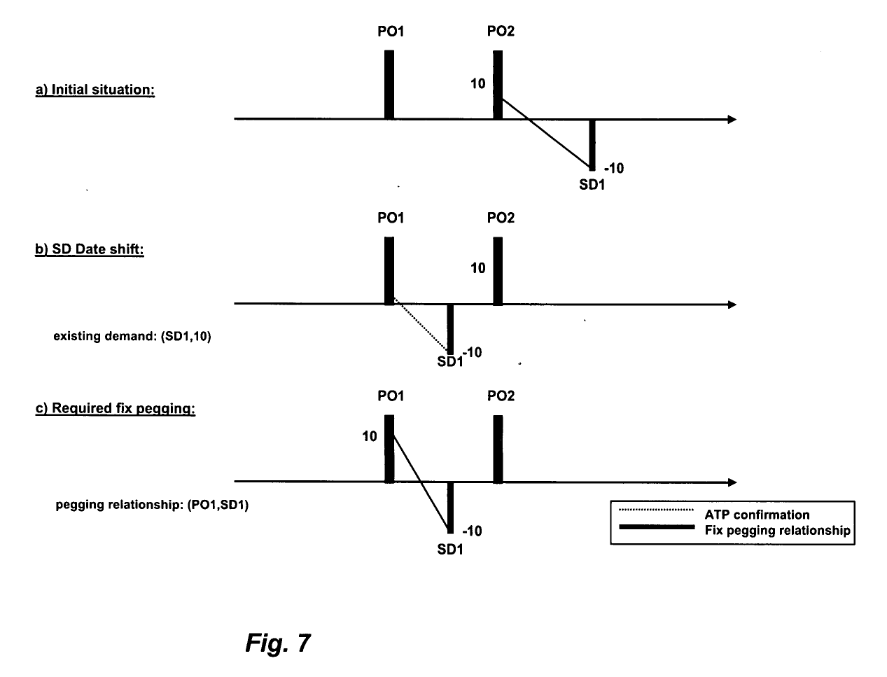

In the example shown in FIG. 7, an existing sales order SD1 is modified in R/3 by shifting the requested date backward. The ATP confirmation is then executed using the new date. In this example, the synchronization module 200 deletes the existing fixed-pegging relationship between sales order SD1 and receipt PO2 and creates a new fixed pegging relationship between the shifted sales order SD1 and a more appropriate receipt PO1 (using a flow quantity of 10 in the example).

(f) Sales Order with Several Scheduling Lines

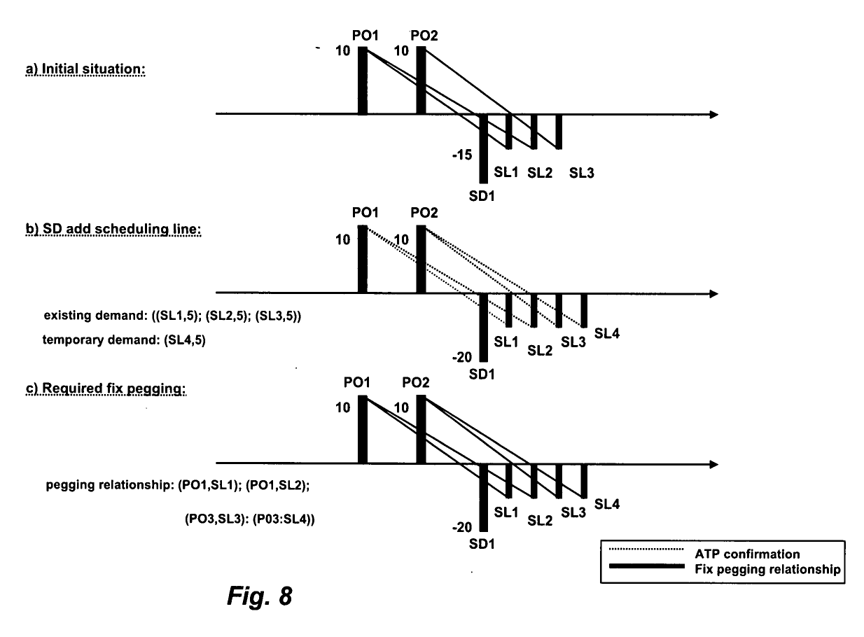

A single order may have multiple scheduling lines. In the example shown in FIG. 8, an existing sales order SD1 with existing confirmed scheduling lines SL1-SL3 is increased in R/3. Specifically, scheduling line SL4 is added with a quantity of 5. In this example, the synchronization module 200 deletes the existing fix pegging relationships and creates new fix pegging relationships to the confirmed scheduling lines, according to the ATP confirmation for the sales order.

### 2. PPDS/ATP Confirmations Against Fixed-Pegged Receipts

With respect to PPDS/ATP confirmations against fixed-pegged receipts, the existing fixed-pegged relationships to processed sales orders are evaluated as part of the PPDS ATP/CTP confirmation. The existing fixed pegging relationship may restrict the PPDS ATP/CTP confirmation. However, in one embodiment, for newly created receipts within the CTP process, new fixed pegging relationships are created. Based on these principles, one embodiment of the invention will be described using the following examples:
a) Sales order quantity increase
b) Sales order quantity decrease
c) Sales order date is shifted forward
d) Sales order date is shifted backward
e) Sales order with several scheduling lines

(a) Sales Order Quantity Increase

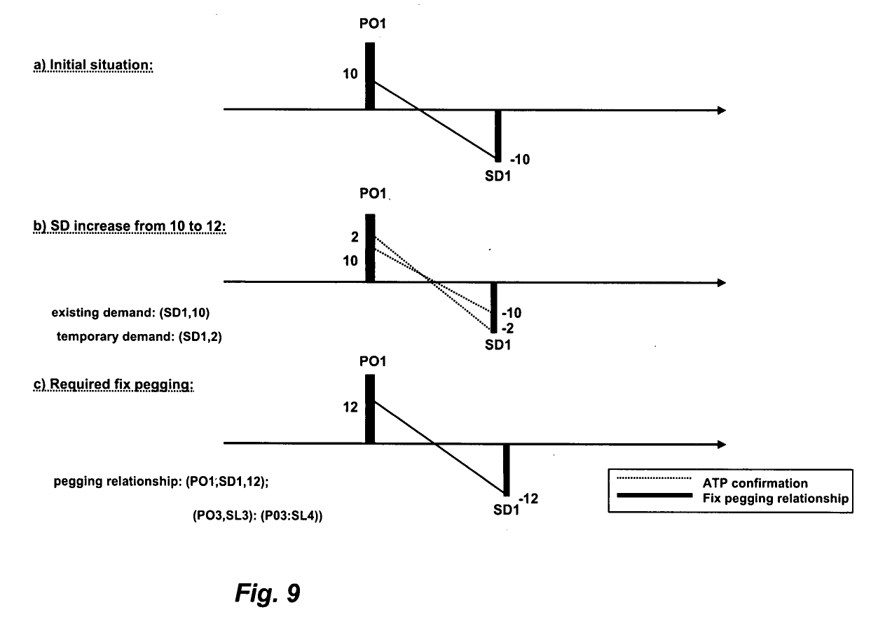

In the example shown in FIG. 9, an existing sales order SD1 is increased in R/3 from 10 to 12. When the PPDS/ATP confirmation is executed, a temporary sales order is created in light of the quantity of the increase (i.e., an increase of 2 in the example). In this example, the synchronization module 200 updates the existing fixed-pegging relationship between the increased sales order SD1 and the receipt PO1 to reflect the new flow quantity of 12. If a new receipt is created during a CTP process, new fixed-pegging relationships are created for the sales order and newly created receipts.

(b) Sales Order Quantity Decrease

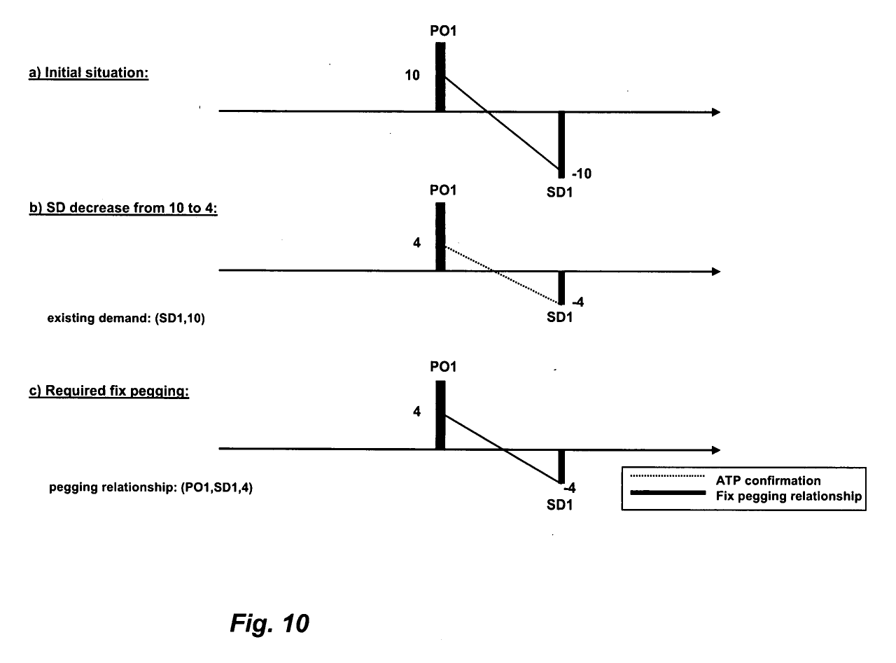

In the example shown in FIG. 10, an existing sales order SD1 is decreased in R/3 from 10 down to 4. Thus, when the PPDS/ATP confirmation is executed, the confirmed quantity decreases to 4. In this example, the synchronization module 200 updates the existing fix pegging relationship between the decreased sales order SD1 and the receipt PO1 to reflect the new flow quantity of 4.

(c) Sales Order Date Shift Forward

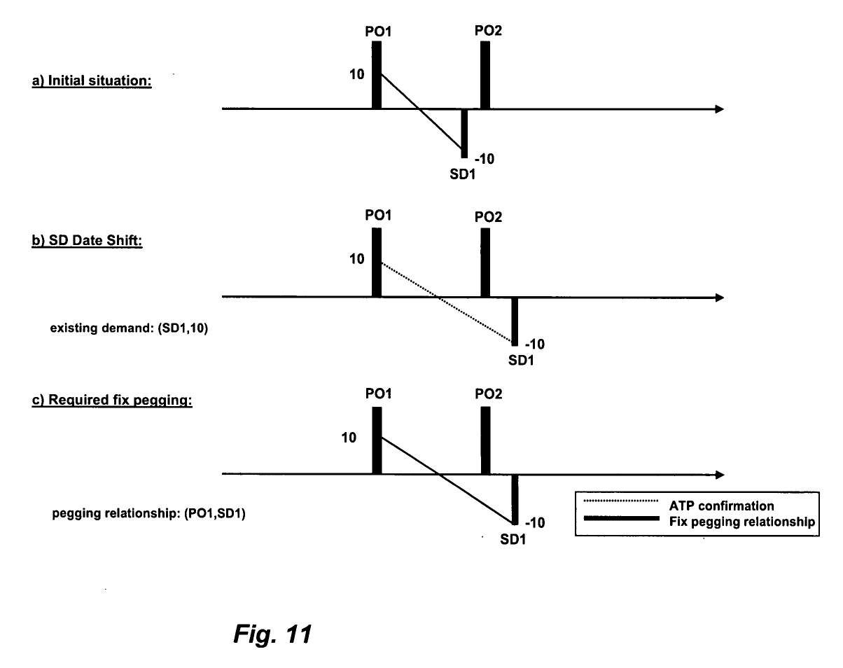

In the example shown in FIG. 11, the request date for a particular sales order SD1 is shifted forward in R/3. Thus, when the PPDS/ATP confirmation is executed, the sales order quantity is shifted forward. In contrast to the embodiment described above with respect to FIG. 6, however, in this embodiment, the synchronization module 200 sustains the existing fixed pegging relationship between the shifted sales order SD1 and the receipt PO1 using a flow quantity of 10.

(d) Sales Order Date Shift Backward

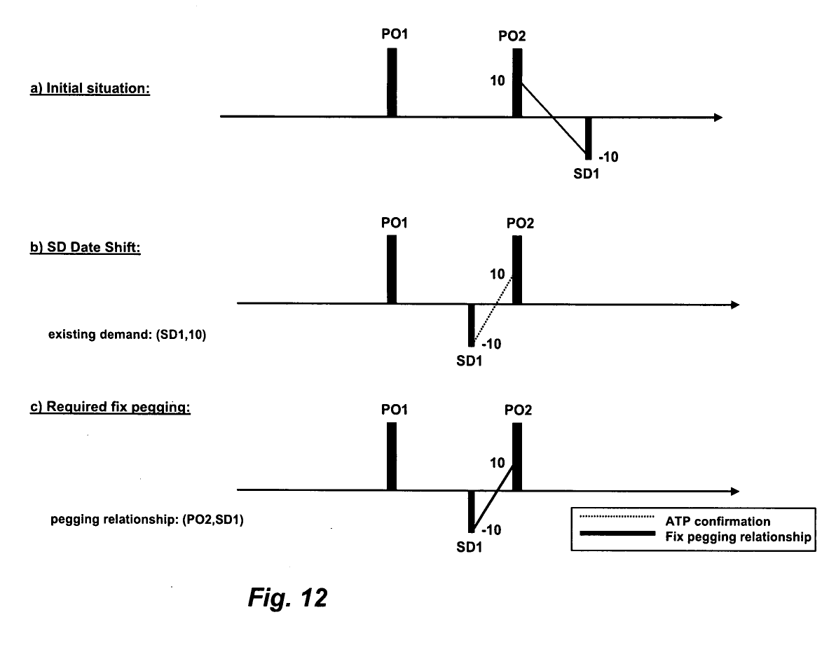

In the example shown in FIG. 12, an existing sales order SD1 is shifted backward in R/3 by changing the requested date. When the PPDS/ATP confirmation is executed, the sales order quantity is shifted backward. In contrast to the embodiment described above with respect to FIG. 7, in this embodiment, the synchronization module 200 sustains the existing fixed pegging relationship between the shifted sales order SD1 and the receipt PO1.

(e) Sales Order with Several Scheduling Lines

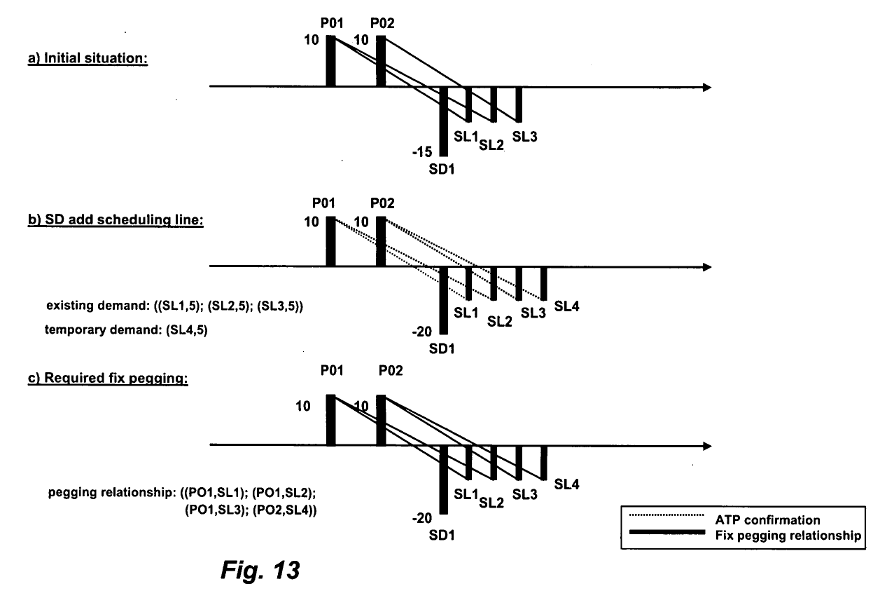

As mentioned above, a single order may have multiple scheduling lines. In the example shown in FIG. 13, an existing sales order SD1 with existing confirmed scheduling lines SL1-SL3 is increased in R/3. Specifically, when the PPDS/ATP confirmation is executed, an additional confirmed scheduling line of the sales order, SL4, is created with a quantity of 5. In this example, the requirement to the fix pegging creation is that the existing fix pegging relationships of the several scheduling lines are sustained and the new fixed-pegging relationships are created according to the ATP confirmations.

3. Fixed-Pegging Relationships for Multi-Level Planning

As mentioned above, it is often necessary to check component availability directly during order creation within a CTP process. In one embodiment of the invention, to support fixed pegging in a multi-level production environment, fixed pegging creation on a dependent requirement level is implemented. In one embodiment of the invention, three different types of actions may be triggered:

(a) Cover Dependent/Stock Transfer Requirements Immediately with Existing Receipts.

This action demands that for a newly created or changed order, the dependent/stock transfer requirements must be covered by existing receipts. If this is not the case, the order is deleted. If the dependent stock transfer requirements are covered later in time, the order must be scheduled forward in time accordingly. Thus, the order is allowed to be created or changed only when the dependent/stock transfer requirements are covered in time.

(b) Cover Dependent/Stock Transfer Requirements Immediately.

This action demands that for a new created or changed order the dependent/stock transfer requirements must be covered by existing receipts. If this is not the case, creation of new receipts on component level is triggered and the availability check is performed again for the order (in contrast to (a) above). If the dependent/stock transfer requirements are not covered, the order is deleted. If the dependent/stock transfer requirements are covered later in time, the order is scheduled in time accordingly.

(c) Cover Dependent/Stock Transfer Requirements Immediately if Possible.

This action demands that for a newly-created or changed order the dependent/stock transfer requirements are covered by existing receipts, if possible. If the dependent requirement is not covered, creation of new receipts on the component level is triggered and the availability check is performed again for the order. If the dependent/stock transfer requirements are not covered, however, the order is not deleted. If the dependent/stock transfer requirements are covered later in time, the order is not scheduled in time accordingly.

In one embodiment of the invention, for all three techniques described above, an availability check is performed to define material flow on the component level. Thus, in this embodiment of the invention, the creation of fixed pegging relationships can also help to define the material flow, since with existing fixed pegging relationships the determination of availability quantities is much simpler and more stable.

The following different examples will be used to illustrate the requirements for implementing fixed pegging on the component level when an availability check is performed:
a) Creation of dependent requirement
b) Increase of dependent requirement
c) Decrease of dependent requirement
d) Dependent requirement is shifted forward
e) Dependent requirement is shifted backward

(a) Creation of Dependent Requirement

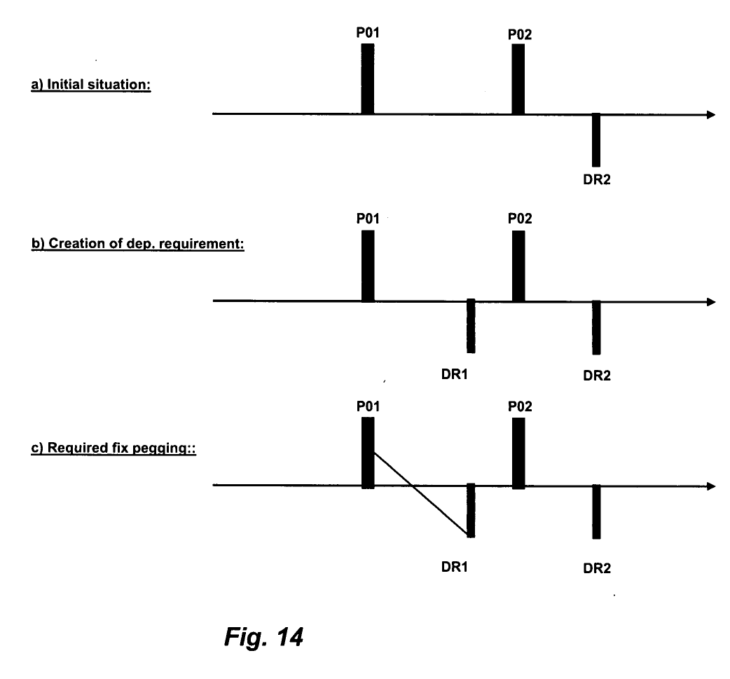

In the example shown in FIG. 14, a new dependent requirement DR1 is created. When the multilevel planning action is performed all existing demands and receipts are taken into account as part of a “net requirements” calculation. Finally the dependent requirement is allocated to the available receipt PO1. Thus, in this example, the fixed pegging requirement is that a fixed pegging relationship is created between the dependent requirement DR1 and the available receipt PO1.

(b) Increase of Requirement Quantity

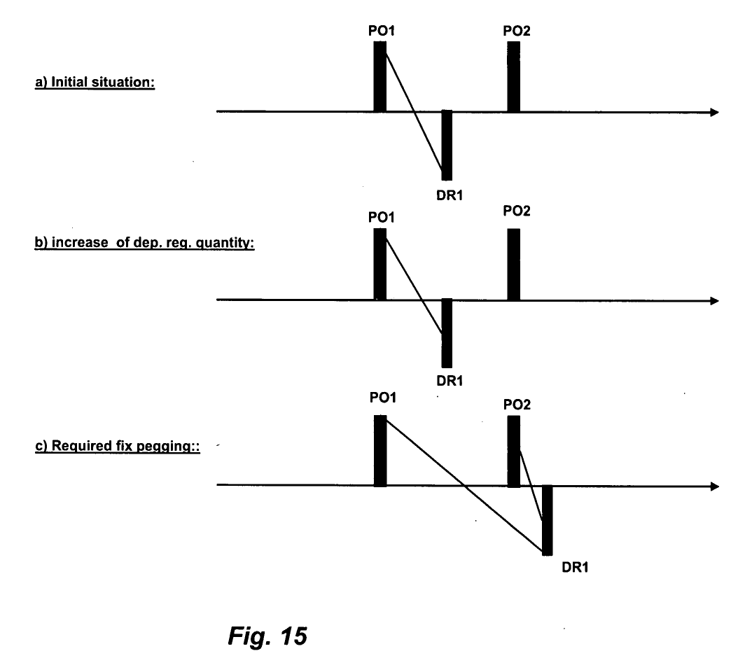

In the example shown in FIG. 15, the quantity for an existing dependent requirement DR1 with fixed pegging relationship to a receipt PO1 is increased. When the multilevel planning action is performed by PPDS 201, the dependent requirement DR1 is allocated to both the fixed-pegged receipt PO1 and the later available receipt PO2. Due to the component availability check, the dependent requirement DR1 may need to be scheduled after the date of receipt PO2 depending on the multilevel planning action type. In this specific example, the dependent requirement DR1 is scheduled after PO2, and fix-pegged to both the formerly fix-pegged receipt PO1 and to the newly allocated receipt PO2.

(c) Decrease of Dependent Requirement Quantity

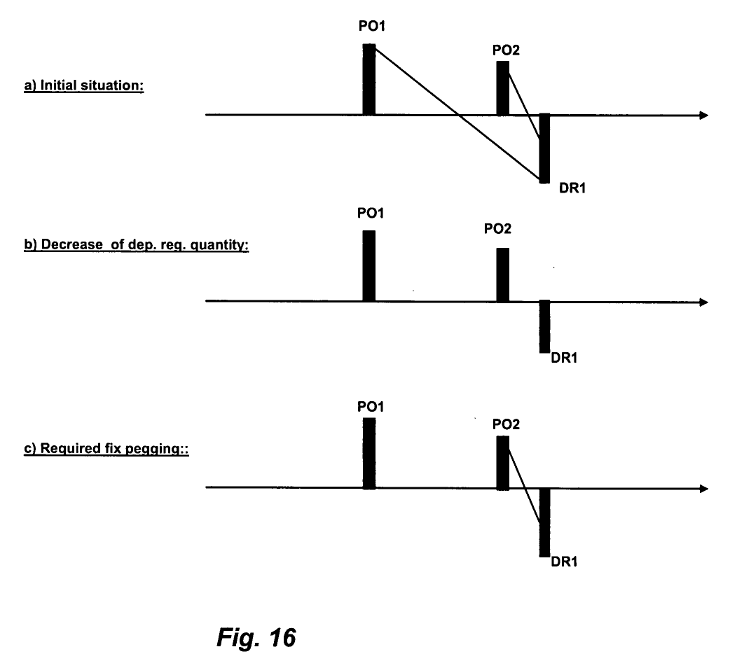

In the example shown in FIG. 16, an existing dependent requirement DR1 with existing fixed pegging relationships to two receipt, PO1 and PO2, is reduced in its quantity. As a result, when the multilevel planning action is executed by PPDS 201, the dependent requirement DR1 is entirely allocated to the receipt PO2 since this receipt is later in time than receipt PO1 (i.e., thereby reducing warehousing costs). Thus, in this example, the dependent requirement DR1 will be entirely fix-pegged to the receipt PO2.

(d) Forwarded Shift of the Dependent Requirements Date

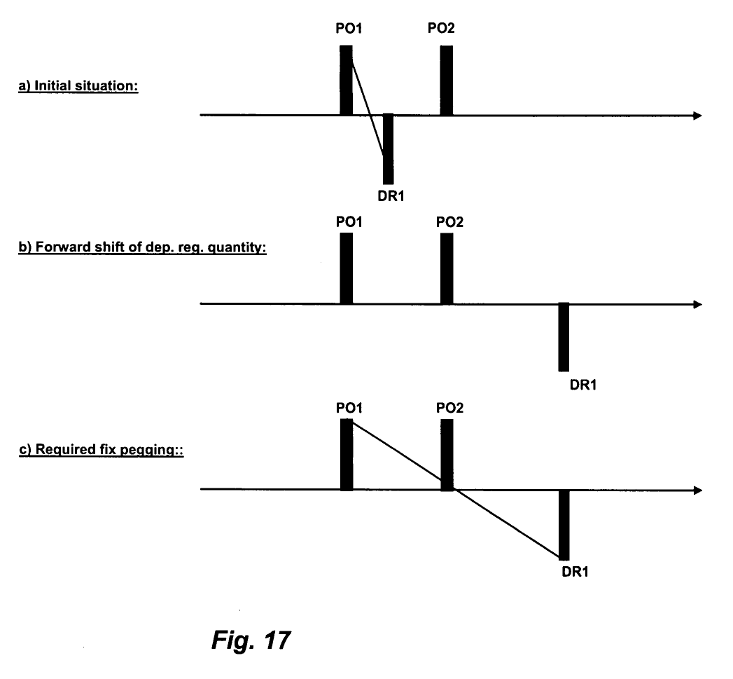

In the example shown in FIG. 17, an existing dependent requirement DR1 is initially fix-pegged to receipt PO1. In this example, the requirement to the fixed pegging creation is that the fixed pegging relationship between DR1 and PO1 will be maintained. Thus, when performing the multilevel planning action the allocation of the dependent requirement DR1 to the receipt PO1 is maintained upon a forwarded shift of the dependent requirement. In an alternate implementation, the dependent requirement may be fix-pegged to receipt PO2 in response to the shift.

(e) Backward Shift of Dependent Requirements Date

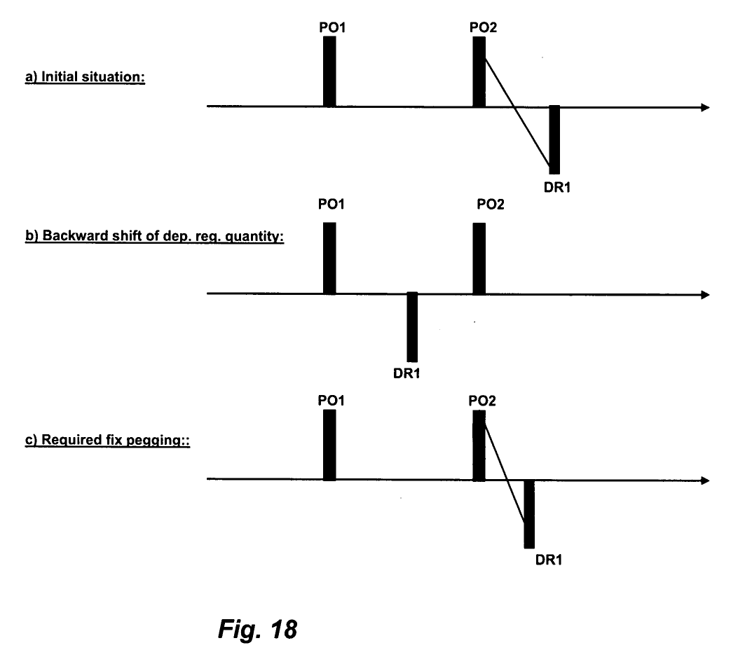

In the example shown in FIG. 18, an existing dependent requirement DR1 fix-pegged to receipt PO2 is shifted backward in time. When performing he multilevel planning action, the dependent requirement DR1 will again be allocated to receipt PO2. Due to the component availability check the dependent requirement DR1 can only be shifted up to the date of receipt PO2, depending on the multilevel planning action type. In this example the requirement to the fixed pegging creation is that the fixed pegging relationship between the dependent requirement DR1 and receipt PO2 will be maintained.

Throughout the description, for the purposes of explanation, numerous specific examples were provided in order to convey an understanding of the present invention. It will be apparent, however, to one skilled in the art that the present invention may be practiced without some of these specific details.

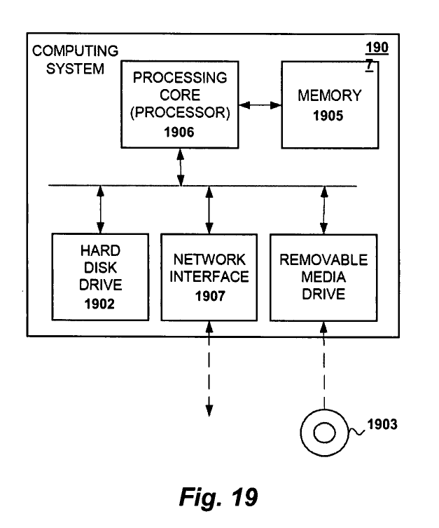

FIG. 19 is a block diagram of an exemplary computing system 800 that can execute program code stored by an article of manufacture. It is important to recognize that the computing system block diagram of FIG. 19 is just one of various computing system architectures on which the embodiments of the invention may be implemented. The applicable article of manufacture may include one or more fixed components (such as a hard disk drive 1902 or memory 1905) and/or various movable components such as a CD ROM 1903, a compact disc, a magnetic tape, etc. In order to execute the program code, typically instructions of the program code are loaded into the Random Access Memory (RAM) 1905; and, the processing core 1906 then executes the instructions. The processing core may include one or more processors and a memory controller function. A virtual machine or “interpreter” (e.g., a Java Virtual Machine) may run on top of the processing core (architecturally speaking) in order to convert abstract code (e.g., Java bytecode) into instructions that are understandable to the specific processor(s) of the processing core 1906. In one particular embodiment, the computing system 1900 is the SAP Web Application Server currently available from SAP AG.

It is believed that processes taught by the discussion above can be practiced within various software environments such as, for example, object-oriented and non-object-oriented programming environments, Java based environments (such as a Java 2 Enterprise Edition (J2EE) environment or environments defined by other releases of the Java standard), or other environments (e.g., a .NET environment, a Windows/NT environment each provided by Microsoft Corporation).

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

The present invention may also be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although the description above focused on single-activity resources, the same general principles apply to other resources (e.g., multi-activity resources). Accordingly, the scope and spirit of the invention should be judged in terms of the claims which follow.

What is claimed is:

1. A computer-implemented method comprising:
receiving an indication of a new sales order having associated therewith a desired quantity and a desired delivery date;
determining whether the desired quantity can be promised by the desired delivery date based on current receipts; and
generating a fixed pegging relationship between the new sales order and receipts identified to satisfy the sales order if the desired quantity can be promised by the desired date.

2. The method as in claim 1 further comprising:
after determining that the desired quantity can be delivered by the desired date, requesting a confirmation from a customer to enter the sales order; and
generating the fixed pegging relationship responsive to receipt of the confirmation.

3. The method as in claim 1 further comprising:
receiving an indication of a change to the quantity of the sales order; and
responsively deleting the fixed pegging relationship between the sales order and receipts, and reestablishing a fixed pegging relationship between the sales order and receipts to reflect the change in quantity.

4. The method as in claim 1 further comprising:
receiving an indication of a change to the desired date of the sales order; and
based on the change to the desired date, responsively determining whether to maintain the fixed pegging relationship to the receipts initially identified to satisfy the sales order, or to establish a new fixed pegging relationship to alternate receipts.

5. The method as in claim 4 further comprising:
establishing the new fixed pegging relationship to the alternate receipts if the alternate receipts occur earlier in time than the desired date but relatively closer in time to the desired date than did the initial receipts.

6. The method as in claim 1 further comprising:
receiving an indication of a change to the desired date of the sales order;
changing the desired date; and
maintaining the fixed pegging relationship notwithstanding the change in the desired date.

7. The method as in claim 1 wherein the sales order comprises several scheduling lines and wherein the fixed pegging is established between the receipts and each of the scheduling lines.

8. The method as in claim 7 further comprising:
receiving an indication of a change to the initial scheduling lines; and
responsively deleting the existing fixed pegging relationships between the initial scheduling lines and the receipts, and establishing new fixed pegging relationships between the receipts and the new scheduling lines created as a result of the change.

9. A supply-chain management computer system including a memory for storing program code and a processor for processing the program code, to cause the processor to perform the operations of:
receiving an indication of a new sales order having associated therewith a desired quantity and a desired delivery date;
determining whether the desired quantity can be promised by the desired delivery date based on current receipts; and
generating a fixed pegging relationship between the new sales order and receipts identified to satisfy the sales order if the desired quantity can be promised by the desired date.

10. The computer system as in claim 9 comprising additional program code to cause the processor to perform the operations of:
after determining that the desired quantity can be delivered by the desired date, requesting a confirmation from a customer to enter the sales order; and
generating the fixed pegging relationship responsive to receipt of the confirmation.

11. The computer system as in claim 9 comprising additional program code to cause the processor to perform the operations of:
receiving an indication of a change to the quantity of the sales order; and
responsively deleting the fixed pegging relationship between the sales order and receipts, and reestablishing a fixed pegging relationship between the sales order and receipts to reflect the change in quantity.

12. The computer system as in claim 9 comprising additional program code to cause the processor to perform the operations of:
receiving an indication of a change to the desired date of the sales order; and
based on the change to the desired date, responsively determining whether to maintain the fixed pegging relationship to the receipts initially identified to satisfy the sales order, or to establish a new fixed pegging relationship to alternate receipts.

13. The computer system as in claim 12 comprising additional program code to cause the processor to perform the operations of:
establishing the new fixed pegging relationship to the alternate receipts if the alternate receipts occur earlier in time than the desired date but relatively closer in time to the desired date than did the initial receipts.

14. The computer system as in claim 9 comprising additional program code to cause the processor to perform the operations of:
receiving an indication of a change to the desired date of the sales order;
changing the desired date; and
maintaining the fixed pegging relationship notwithstanding the change in the desired date.

15. The computer system as in claim 9 wherein the sales order comprises several scheduling lines and wherein the fixed pegging is established between the receipts and each of the scheduling lines.

16. The computer system as in claim 15 comprising additional program code to cause the processor to perform the operations of:
receiving an indication of a change to the initial scheduling lines; and
responsively deleting the existing fixed pegging relationships between the initial scheduling lines and the receipts, and establishing new fixed pegging relationships between the receipts and the new scheduling lines created as a result of the change.

17. A machine-readable medium having stored thereon sequences of instructions which, when executed by a machine, cause the machine to perform the operations of:
receiving an indication of a new sales order having associated therewith a desired quantity and a desired delivery date;
determining whether the desired quantity can be promised by the desired delivery date based on current receipts; and
generating a fixed pegging relationship between the new sales order and receipts identified to satisfy the sales order if the desired quantity can be promised by the desired date.

18. The machine-readable medium as in claim 17 comprising additional program code to cause the processor to perform the operations of:
after determining that the desired quantity can be delivered by the desired date, requesting a confirmation from a customer to enter the sales order; and
generating the fixed pegging relationship responsive to receipt of the confirmation.

19. The machine-readable medium as in claim 17 comprising additional program code to cause the processor to perform the operations of:
receiving an indication of a change to the quantity of the sales order; and
responsively deleting the fixed pegging relationship between the sales order and receipts, and reestablishing a fixed pegging relationship between the sales order and receipts to reflect the change in quantity.

20. The machine-readable medium as in claim 17 comprising additional program code to cause the processor to perform the operations of:
receiving an indication of a change to the desired date of the sales order; and
based on the change to the desired date, responsively determining whether to maintain the fixed pegging relationship to the receipts initially identified to satisfy the sales order, or to establish a new fixed pegging relationship to alternate receipts.

21. The machine-readable medium as in claim 20 comprising additional program code to cause the processor to perform the operations of:
establishing the new fixed pegging relationship to the alternate receipts if the alternate receipts occur earlier in time than the desired date but relatively closer in time to the desired date than did the initial receipts.

22. The machine-readable medium as in claim 17 comprising additional program code to cause the processor to perform the operations of:
receiving an indication of a change to the desired date of the sales order;
changing the desired date; and
maintaining the fixed pegging relationship notwithstanding the change in the desired date.

23. The machine-readable medium as in claim 17 wherein the sales order comprises several scheduling lines and wherein the fixed pegging is established between the receipts and each of the scheduling lines.

24. The machine-readable medium as in claim 23 comprising additional program code to cause the processor to perform the operations of:
receiving an indication of a change to the initial scheduling lines; and
responsively deleting the existing fixed pegging relationships between the initial scheduling lines and the receipts, and establishing new fixed pegging relationships between the receipts and the new scheduling lines created as a result of the change.
